(19) United States
(12) Patent Application Publication
(10) Pub. No.: US 2025/0342443 A1
(43) Pub. Date: Nov. 6, 2025

(54) METHOD AND SYSTEM FOR PROVIDING AUTOMATED TICKET RESOLUTION

(71) Applicant: JPMorgan Chase Bank, N.A., New York, NY (US)

(72) Inventors: Srinivasan RAJU, Bangalore (IN); Anshul GOSWAMI, Bengaluru (IN); Gopal NAYAK, Bangalore (IN)

(73) Assignee: JPMorgan Chase Bank, N.A., New York, NY (US)

(21) Appl. No.: 19/194,952

(22) Filed: Apr. 30, 2025

(30) Foreign Application Priority Data
May 2, 2024 (IN) 202411034791

(51) Int. Cl. G06Q 10/10; G06Q 10/0631; G06Q 30/015

(52) U.S. Cl. CPC G06Q 10/103; G06Q 10/063118; G06Q 30/015

(57) ABSTRACT

A system and method for providing an automated ticket resolution are disclosed. The method includes registering at least one queue owner upon successful completion of an onboarding of the at least one queue owner. The method includes receiving a ticket data from the at least one queue owner, the ticket data comprises data associated with a plurality of tickets and corresponding resolution of the plurality of tickets. The method further includes loading the ticket data into a data repository to train a model for the automated ticket resolution. The method includes receiving at least one ticket via a ticket management platform. The method further includes identifying a resolution for the at least one ticket using the model trained from the ticket data. The method includes executing the identified resolution to resolve the at least one ticket.

### CROSS-REFERENCE TO RELATED APPLICATIONS

This application claims priority benefit from Indian application Ser. No. 202411034791, filed on May 2, 2024, in the India Patent Office, which is hereby incorporated by reference in its entirety.

### FIELD OF THE DISCLOSURE

This technology generally relates to ticket management, and more particularly relates to methods and systems for providing an automated ticket resolution for a large number of tickets.

### BACKGROUND INFORMATION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

In today's world, various entities such as companies and organisations are exploring new approaches to control risk, minimize expenses, and promote growth. However, they often struggle with digital sprawl, which is the result of abundance of data dispersed across numerous systems and suppliers, making it challenging to link, coordinate, and organise in a way that produces effective results and processes. For instance, customer-oriented organisations have to deal with the management of customer service complaints (e.g., management of tickets raised by customers) at some point, and responding to those complaints may help to cement people's loyalty to the organisation. Therefore, ticket management is important and necessary for such entities to provide better services to their customers.

Currently, there are some query or ticket management software(s) available in the market for solving user tickets or complaints. However, the existing software(s) fails to provide satisfactory resolutions for a large number of tickets generated for various departments of any organisation by users on a daily basis. While existing tools may offer general scripted solutions and recommendations for tickets raised by users, they often lack the ability to dynamically adjust according to the specific needs of query or queue owners, such as helpdesk technicians, site reliability engineering (SRE) teams, and human resource (HR) teams. Furthermore, these tools often lack the ability to resolve a significant number of tickets across various categories, necessitating manual intervention. This deficiency may result in poor user experience, and may lead to excessive use of computing resources (e.g., from a person researching a ticket, providing a failed resolution, re-researching the ticket, providing another resolution, etc.). In other cases, resolving a ticket issue (with or without human intervention) may be difficult due to the ticket management software(s) receiving a large volume of ticket data relating to a multitude of different issues. This may result in high computer processing and/or increased memory utilizations, thereby wasting processor resources, memory resources, and/or the like, adding complexity to the overall system or process, failing to resolve data integration or synchronization or transfer issues among various computer implemented tools having various heterogenous systems running therein and subjecting the overall systems to malicious cyber-attacks due to the manual nature of defining and resolving the high number of tickets. This deficiency also impacts on the organization's efficiency in handling the high volume of tickets.

Hence, in view of these and other existing limitations, there arises an imperative need to provide an efficient solution to overcome the above-mentioned limitations and a method and system capable of efficiently resolving a large volume of tickets from diverse domains, originating from various departments of the organization.

### SUMMARY

The present disclosure, through one or more of its various aspects, embodiments, and/or specific features or sub-components, provides, inter alia, various systems, servers, devices, methods, media, programs, and platforms for providing an automated ticket resolution.

According to an aspect of the present disclosure, a method for providing an automated ticket resolution is disclosed. The method is implemented by at least one processor. The method includes registering, by the at least one processor, at least one queue owner upon successful completion of an onboarding of the at least one queue owner. The method further includes receiving, by the at least one processor, a ticket data from the at least one queue owner, the ticket data includes data associated with a plurality of tickets and corresponding resolution of the plurality of tickets. The method further includes loading, by the at least one processor, the ticket data into a data repository to train a model for the automated ticket resolution. The method further includes receiving, by the at least one processor, at least one ticket via a ticket management platform. The method further includes identifying, by the at least one processor, a resolution for the at least one ticket using the model trained from the ticket data. The method further includes executing, by the at least one processor, the identified resolution to resolve the at least one ticket.

In accordance with an exemplary embodiment, for the onboarding of the at least one queue owner, the method may further include receiving, by the at least one processor, onboarding details from the at least one queue owner. The method further includes authenticating, by the at least one processor, the at least one queue owner. The method further includes authorizing, by the at least one processor, the at least one queue owner based on the onboarding details.

In accordance with an exemplary embodiment, the onboarding details may include a name, a location, a role, and a department of the at least one queue owner.

In accordance with an exemplary embodiment, the method may further include updating, by the at least one processor, a ticket status of the at least one ticket as an unresolved ticket upon failure of the identification of the resolution for the at least one ticket. The method further includes transmitting, by the at least one processor, the at least one unresolved ticket to a ticket resolution team for a manual resolution of the at least one unresolved ticket.

In accordance with an exemplary embodiment, the resolution of the at least one unresolved ticket may further be loaded into the data repository for self-training of the model for the automated ticket resolution.

In accordance with an exemplary embodiment, the ticket data may further be uploaded in at least one format from among: a javascript object notation (JSON) format, an extensible markup language (XML) format, and a comma separated values (CSV) format.

In accordance with an exemplary embodiment, the method may further include transmitting, by the at least one processor, a notification to the user via the ticket management platform upon a successful resolution of the at least one ticket.

According to another aspect of the present disclosure, a computing device configured to implement an execution of a method for providing an automated ticket resolution is disclosed. The computing device includes a processor; a memory storing instructions; and a communication interface coupled to each of the processor and the memory. The processor may be programmed to cooperate with the instructions to perform operations including: registering at least one queue owner upon successful completion of an onboarding of the at least one queue owner; receiving a ticket data from the at least one queue owner, the ticket data includes data associated with a plurality of tickets and corresponding resolution of the plurality of tickets; loading the ticket data into a data repository to train a model for the automated ticket resolution; receiving at least one ticket via a ticket management platform; identifying a resolution for the at least one ticket using the model trained from the ticket data and executing the identified resolution to resolve the at least one ticket.

In accordance with an exemplary embodiment, to onboard the at least one queue owner, the operations may further include: receiving onboarding details from the at least one queue owner; authenticating the at least one queue owner and authorizing the at least one queue owner based on the onboarding details.

In accordance with an exemplary embodiment, the onboarding details may include a name, a location, a role, and a department of the at least one queue owner.

In accordance with an exemplary embodiment, the operations may further include: updating a ticket status of the at least one ticket as an unresolved ticket upon failure of the identification of resolution for the at least one ticket and transmitting the at least one unresolved ticket to a ticket resolution team for a manual resolution of the at least one unresolved ticket.

In accordance with an exemplary embodiment, the resolution of the at least one unresolved ticket may further be loaded into the data repository for self-training of the model for the automated ticket resolution.

In accordance with an exemplary embodiment, the ticket data may further be uploaded in at least one format from among a javascript object notation (JSON) format, an extensible markup language (XML) format, and a comma separated values (CSV) format.

In accordance with an exemplary embodiment, the operations may further include: transmitting a notification to the user via the ticket management platform upon a successful resolution of the at least one ticket.

According to yet another aspect of the present disclosure, a non-transitory computer-readable storage medium storing instructions for providing an automated ticket resolution is disclosed. The instructions include executable code which, when executed by a processor, may cause the processor to perform operations including: registering, via a communication interface, at least one queue owner upon successful completion of an onboarding of the at least one queue owner; receiving a ticket data from the at least one queue owner, the ticket data includes data associated with a plurality of tickets and corresponding resolution of the plurality of tickets; loading the ticket data into a data repository to train a model for the automated ticket resolution; receiving at least one ticket via a ticket management platform; identifying a resolution for the at least one ticket using the model trained from the ticket data; and executing the identified resolution to resolve the at least one ticket.

In accordance with an exemplary embodiment, to onboard the at least one queue owner, the operations further include receiving onboarding details from the at least one queue owner; authenticate the at least one queue owner; and authorizing the at least one queue owner based on the onboarding details.

In accordance with an exemplary embodiment, the onboarding details may include a name, a location, a role, and a department of the at least one queue owner.

In accordance with an exemplary embodiment, operations may further include updating a ticket status of the at least one ticket as an unresolved ticket upon failure of the identification of resolution for the at least one ticket; and transmitting the at least one unresolved ticket to a ticket resolution team for a manual resolution of the at least one unresolved ticket.

In accordance with an exemplary embodiment, the operations may further include loading the resolution of the at least one unresolved ticket into the data repository for self-training of the model for the automated ticket resolution.

In accordance with an exemplary embodiment, the operations may further include uploading the ticket data in at least one format from among a javascript object notation (JSON) format, an extensible markup language (XML) format, and a comma separated values (CSV) format.

In accordance with an exemplary embodiment, the operations may further include transmitting a notification to the user via the ticket management platform upon a successful resolution of the at least one ticket.

### BRIEF DESCRIPTION OF THE DRAWINGS

The present disclosure is further described in the detailed description which follows, in reference to the noted plurality of drawings, by way of non-limiting examples of exemplary embodiments of the present disclosure, in which like characters represent like elements throughout the several views of the drawings.

FIG. 1 illustrates an exemplary computer system for providing an automated ticket resolution, in accordance with an exemplary embodiment of the present disclosure.

FIG. 2 illustrates an exemplary diagram of a network environment for providing an automated ticket resolution, in accordance with an exemplary embodiment of the present disclosure.

FIG. 3 illustrates an exemplary system for providing an automated ticket resolution, in accordance with an exemplary embodiment of the present disclosure.

FIG. 4 illustrates an exemplary method flow diagram for providing an automated ticket resolution, in accordance with an exemplary embodiment of the present disclosure.

FIG. 5 illustrates a process flow diagram usable for implementing a method for providing an automated ticket resolution, in accordance with an exemplary embodiment of the present disclosure.

FIG. 6 illustrates a block diagram usable for implementing a method for providing an automated ticket resolution, in accordance with an exemplary embodiment of the present disclosure.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures include the software and/or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples include executable code that, when executed by one or more processors, causes the processors to carry out steps necessary to implement the methods of the examples of this technology that are described and illustrated herein.

As mentioned earlier, conventional query or ticket management software(s) often lack the ability to resolve a significant number of tickets across various categories, necessitating manual intervention. This deficiency may result in poor user experience, and may lead to excessive use of computing resources (e.g., from a person researching a ticket, providing a failed resolution, re-researching the ticket, providing another resolution, etc.). In other cases, resolving a ticket issue (with or without human intervention) may be difficult due to the ticket management software(s) receiving a large volume of ticket data relating to a multitude of different issues. This may result in high computer processing and/or increased memory utilizations, thereby wasting processor resources, memory resources, and/or the like, adding complexity to the overall system or process, failing to resolve data integration or synchronization or transfer issues among various computer implemented tools having various heterogenous systems running therein and subjecting the overall systems to malicious cyber-attacks due to the manual nature of defining and resolving the high number of tickets. For example, applying a ticket management system in a field that uses big data may require resolving issues for tens of thousands, hundreds of thousands, or even millions of tickets. As mentioned above, these conventional tools often lack the ability to resolve a significant number of tickets across various categories, necessitating manual intervention. This deficiency impacts on the organization's efficiency in handling the high volume of tickets and increases power and memory consumption of underlying systems.

To overcome the above-mentioned problems, the present disclosure provides a method and system for providing an automated ticket resolution. Furthermore, the system and method described herein may utilize a rigorous, computerized process to generate automation plans, and resolve tickets that were not previously performed or were previously performed using subjective human intuition or input. For example, currently conventional tools lack a technique to accurately generate an automation plan for automating resolution of thousands, millions, or tens of millions of tickets. Automating the process for generating an automation plan conserves computing resources (e.g., processor resources, memory resources, and/or the like) that would otherwise be wasted in attempting to manually and inefficiently complete ticket resolution tasks that may be automatable, by ensuring that automatable ticket resolution procedures are implemented when available for a particular ticket.

For example, the system facilitates the automated resolution for a plurality of tickets accumulated into queues of an organization provided by various queue owners. The present disclosure provides a cost-effective solution as it provides resolution to a large number of tickets with minimal manual assistance from support technicians or assistants. The present disclosure receives input training data from a queue owner and the same is used to train the model for the resolution of the tickets. The present disclosure automatically identifies the resolution for tickets received in the queue(s) by using the model trained from the input training data. More particularly, the present disclosure first monitors and identifies a resolution for incoming tickets and executes the identified resolution to automate the process of resolving tickets and thus reduce the cost of resolving a large number of tickets. The present disclosure further notifies a user upon the successful resolution of the at least one ticket. If a ticket resolution is unavailable for the at least one ticket in the data repository, then the present disclosure updates the ticket status for the particular ticket as an unresolved ticket and sends the unresolved ticket for a manual resolution. Finally, the present disclosure allows the loading of the resolution of the unresolved tickets into the data repository for self-training of the model for the automated ticket resolution. Thus, the present disclosure facilitates the automated ticket resolution for different types of tickets received in different types of queues. Therefore, the present disclosure eliminates the need to use a dedicated customized trained model for ticket resolution of various departments within the organization.

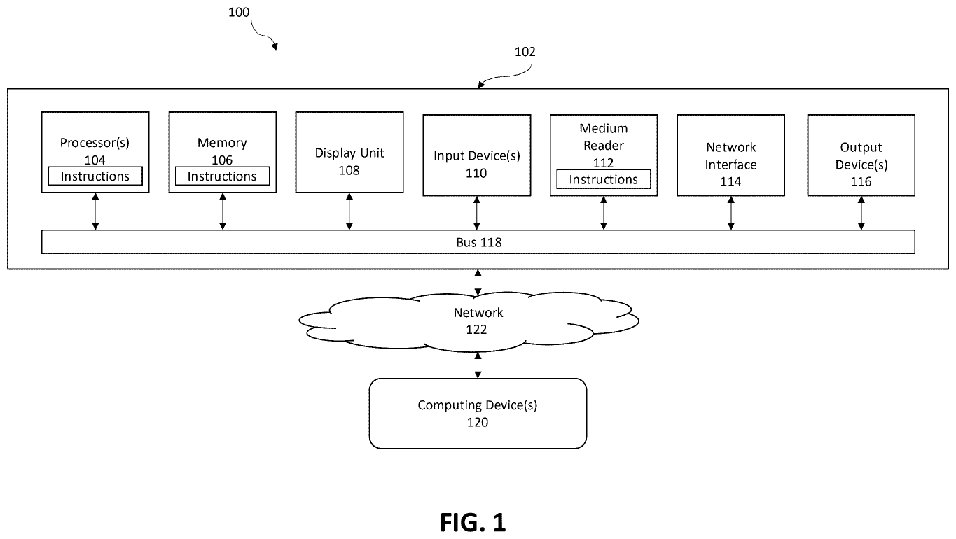

FIG. 1 is an exemplary system for use in accordance with the embodiments described herein. The system 100 is generally shown and may include a computer system 102 which is generally indicated. The term “computer system” may also be referred to as “computing device” and such phrases/terms can be used interchangeably in the specifications.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud-based environment. Even further, the instructions may be operative in such cloud-based computing environment.

In a networked deployment, the computer system 102 may operate in the capacity of a server or as a client-user computer in a server-client user network environment, a client-user computer in a cloud-based computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, and unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art will appreciate that various embodiments of the computer system 102 may include multiple input devices 110. Moreover, those skilled in the art will further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor 104, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as but not limited to, a network interface 114 and an output device 116. The output device 116 may include but is not limited to, a speaker, an audio out, a video out, a remote-controlled output, a printer, or any combination thereof. Additionally, the term “Network interface” may also be referred to as “Communication interface” and such phrases/terms can be used interchangeably in the specifications.

Each of the components of the computer system 102 may be interconnected and communicate via a bus 118 or other communication link. As shown in FIG. 1, the components may each be interconnected and communicate via an internal bus. However, those skilled in the art will appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computing devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art will appreciate that additional networks 122 which are known and understood may additionally or alternatively be used and that the exemplary networks 122 are not limiting or exhaustive. Also, while the network 122 is shown in FIG. 1 as a wireless network, those skilled in the art will appreciate that the network 122 may also be a wired network.

The additional computing device 120 is shown in FIG. 1 as a personal computer. However, those skilled in the art will appreciate that, in alternative embodiments of the present application, the computing device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art will appreciate that the above-listed devices are merely exemplary devices and that the computing device 120 may be any additional device or apparatus commonly known and understood in the art without departing from the scope of the present application. For example, the computing device 120 may be the same or similar to the computer system 102. Furthermore, those skilled in the art will similarly understand that the device may be any combination of devices and apparatuses.

Those skilled in the art will appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor 104 described herein may be used to support a virtual processing environment.

As described herein, various embodiments provide methods and systems for providing the automated ticket resolution.

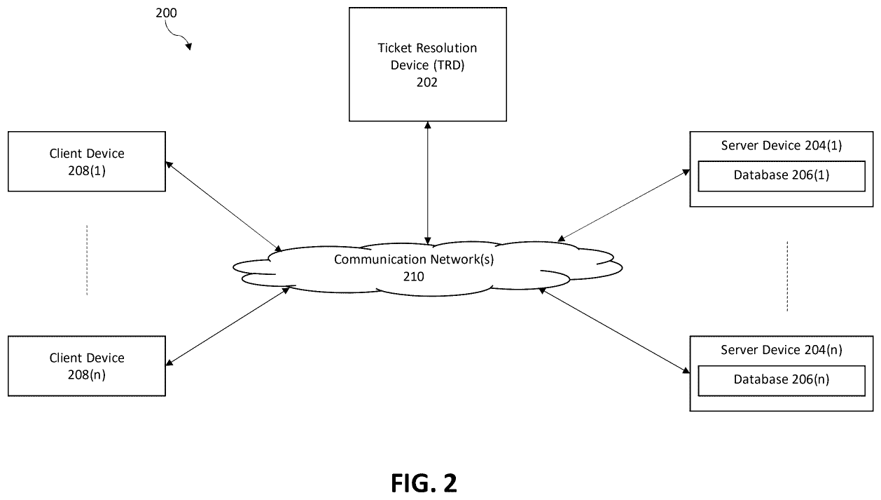

Referring to FIG. 2, a schematic of an exemplary network environment 200 for implementing a method for providing an automated ticket resolution is illustrated. In an exemplary embodiment, the method is executable on any networked computer platform, such as, for example, a personal computer (PC).

The method for providing the automated ticket resolution may be implemented by a ticket resolution device (TRD) 202. The TRD 202 may be the same or similar to the computer system 102 as described with respect to FIG. 1. The TRD 202 may store one or more applications that may include executable instructions that, when executed by the TRD 202, cause the TRD 202 to perform desired actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the TRD 202 itself, may be located in the virtual server(s) running in a cloud-based computing environment rather than being tied to one or more specific physical network computing devices. Also, the application(s) may be running in one or more virtual machines (VMs) executing on the TRD 202. Additionally, in one or more embodiments of this technology, virtual machine(s) running on the TRD 202 may be managed or supervised by a hypervisor.

In the network environment 200 of FIG. 2, the TRD 202 is coupled to a plurality of server devices 204(1)-204(n) that hosts a plurality of databases 206(1)-206(n), and also to a plurality of client devices 208(1)-208(n) via communication network(s) 210. A communication interface of the TRD 202, such as the network interface 114 of the computer system 102 of FIG. 1, operatively couples and communicates between the TRD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the TRD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and TRDs that efficiently implement the method for providing the automated ticket resolution.

By way of example only, the communication network(s) 210 may include local area network(s) (LAN(s)) or wide area network(s) (WAN(s)) and can use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Networks (PSTNs), Ethernet-based Packet Data Networks (PDNs), combinations thereof, and the like.

The TRD 202 may be a standalone device or integrated with one or more other devices or apparatuses, such as one or more of the server devices 204(1)-204(n), for example. In one particular example, the TRD 202 may include or be hosted by one of the server devices 204(1)-204(n), and other arrangements are also possible. Moreover, one or more of the devices of the TRD 202 may be in a same or a different communication network including one or more public, private, or cloud-based networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the TRD 202 via the communication network(s) 210 according to the hypertext transfer protocol (HTTP)-based and/or javascript object notation (JSON) protocol, for example, although other protocols may also be used.

The server devices 204(1)-204(n) may be hardware or software or may represent a system with multiple servers in a pool, which may include internal or external networks. The server devices 204(1)-204(n) host the databases or repositories 206(1)-206(n) that are configured to store data related to at least one queue owner, onboarding details of the at least one queue owner, ticket data provided by the at least one queue owner.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the TRD 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary embodiment, at least one client device 208 is a wireless mobile communication device, e.g., a smartphone.

The client devices 208(1)-208(n) may run interface applications, such as standard web browsers or standalone client applications, which may provide an interface to communicate with the TRD 202 via the communication network(s) 210 in order to communicate user requests and information. The client devices 208(1)-208(n) may further include, among other features, a display device, such as a display unit or touchscreen, and/or an input device, such as a keyboard, for example.

Although the exemplary network environment 200 with the TRD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the TRD 202, the server devices 204(1)-204(n), or the client devices 208(1)-208(n), for example, may be configured to operate as virtual instances on the same physical machine. In other words, one or more of the TRD 202, the server devices 204(1)-204(n), or the client devices 208(1)-208(n) may operate on the same physical device rather than as separate devices communicating through communication network(s) 210. Additionally, there may be more or fewer TRDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

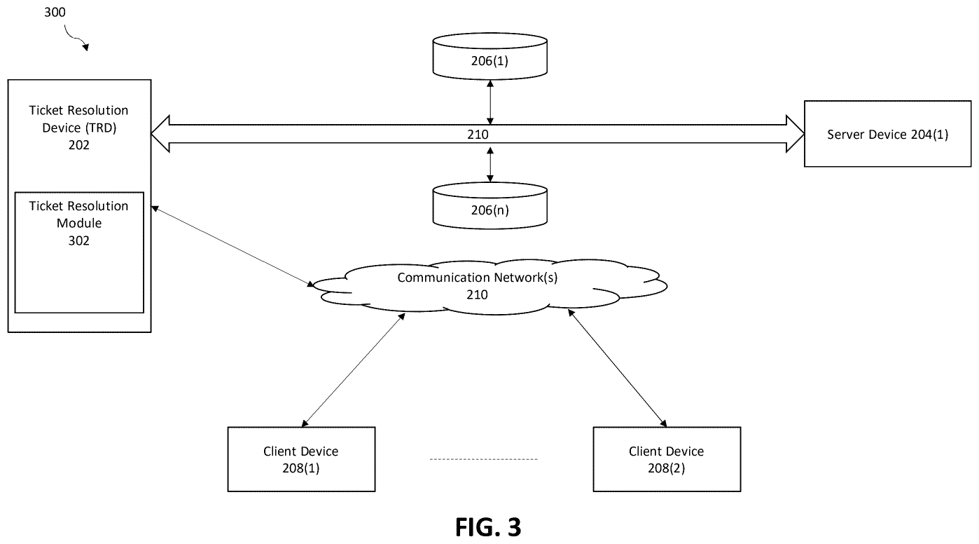

FIG. 3 illustrates an exemplary system for implementing a method for providing an automated ticket resolution, in accordance with an exemplary embodiment. As illustrated in FIG. 3, according to exemplary embodiments, the system 300 may comprise a TRD device 202 including a ticket resolution module (TRM) 302 that may be connected to a server device 204(1) and one or more repository from the repositories 206(1) . . . 206(n) via a communication network 210, but the disclosure is not limited thereto.

The TRD 202 is described and shown in FIG. 3 includes the ticket resolution module 302, although it may include other rules, policies, modules, databases, or applications, for example. As will be described below, the ticket resolution module 302 is configured to implement a method for providing the automated ticket resolution.

An exemplary system 300 for implementing a mechanism for providing the automated ticket resolution by utilizing the network environment of FIG. 2 is shown as being executed in FIG. 3. Specifically, a first client device 208(1) and a second client device 208(2) are illustrated as being in communication with TRD 202. In this regard, the first client device 208(1) and the second client device 208(2) may be “clients” of the TRD 202 and are described herein as such. Nevertheless, it is to be known and understood that the first client device 208(1) and/or the second client device 208(2) need not necessarily be “clients” of the TRD 202, or any entity described in association therewith herein. Any additional or alternative relationship may exist between either or both of the first client device 208(1) and the second client device 208(2) and the TRD 202, or no relationship may exist.

Further, the TRD 202 is illustrated as being able to access one or more repositories 206(1) . . . 206(n). The ticket resolution module 302 may be configured to access these repositories/databases for implementing a method for providing the automated ticket resolution.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the TRD 202 via broadband or cellular communication. These embodiments are merely exemplary and are not limiting or exhaustive.

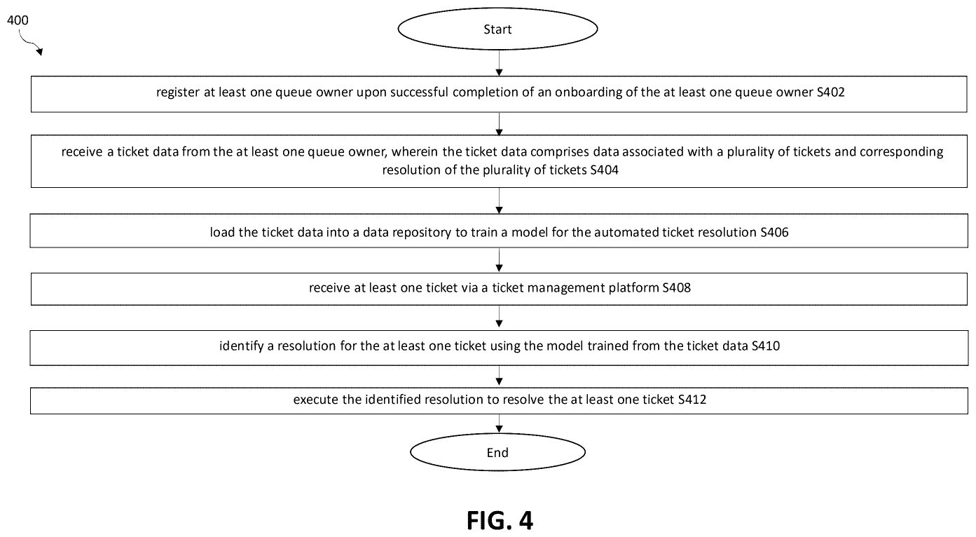

Referring to FIG. 4, an exemplary method 400 is shown for providing the automated ticket resolution, in accordance with an exemplary embodiment. In particular, the exemplary method 400 is shown for providing automated ticket resolution for various types and varieties of tickets.

As shown in FIG. 4, method 400 begins following a need for the automatic ticket resolution for a large number of tickets. A user may wish to initiate the automated ticket resolution process to resolve a large number of tickets. The method 400 is implemented by at least one processor 104.

At step S402, the method 400 includes registering, by the at least one processor 104, at least one queue owner upon successful completion of an onboarding of the at least one queue owner.

In an exemplary implementation, registration of the at least one queue owner may be processed over a user interface (UI) of a user platform. The UI may be part of a centralized web executable platform. The user platform may be installed on a user's device.

The term “queue owner” as used herein may correspond to an employee, support staff, or a ticket resolution team working in one of the various departments of an organization who is responsible for uploading ticker data related to tickets and their corresponding resolution over the user platform.

The term “onboarding” herein may correspond to the process of allowing access of a platform (hereinafter also referred to as the user platform or centralized platform of the organization) to the at least one queue owner that enables a queue owner to sign in to the platform in order to complete a specific online service (e.g., queue registration for automated ticket resolution).

In an exemplary implementation, the user device may include a tablet, a smartphone, a laptop, a desktop computer, a mainframe computer, a phablet, a smart watch, a personal digital assistant (PDA), and the like.

In an exemplary implementation, the UI may be operated by the at least one queue owner.

In an exemplary implementation, the onboarding of the at least one queue owner may include receiving onboarding details from the at least one queue owner. The onboarding details may include the name of at least one queue owner, location of the at least one queue owner, the role, and the department of the at least one queue owner. The method 400 may also include authenticating the at least one queue owner. For example, the system may provide access ID, and login credentials to the at least one queue owner and compare the onboarding details with pre-stored onboarding details to authenticate the at least one queue owner.

The method 400 may further include authorizing the at least one queue owner based on the onboarding details. For example, the system allows the at least one queue owner to access the UI after successful authentication or validation of the onboarding details.

In an exemplary implementation, the onboarding details may be received from the user device associated with queue owners. The onboarding details may include the department of queues (e.g., human resource (HR), site reliability engineering (SRE) etc.), information of the queue owner (e.g., name, age, address, email ID etc.), login credentials (e.g., one-time password or password or pin).

The method 400 employed to receive the onboarding details may include direct queue owner's input through the UI where the user fills out onboarding forms or answers questions.

At step S404, the method 400 includes receiving, by the at least one processor 104, a ticket data from the at least one queue owner. The ticket data may include data associated with a plurality of tickets and the corresponding resolution of the plurality of tickets. In an exemplary implementation, the method 400 for receiving the ticket data may include scanning and processing physical or electronic documents provided by the queue owners, such as data uploaded in a file format (e.g., javascript object notation (JSON), an extensible markup language (XML), and a comma separated values (CSV), etc. In a preferred implementation, the ticket data is uploaded in at least one format from among the javascript object notation (JSON) format, the extensible markup language (XML) format, and the comma separated values (CSV) format.

In an exemplary implementation, the ticket data may be fetched from at least one external source. The at least one external source may be selected from but not limited to, a server, a cloud server, a database, compact flash drives (e.g., universal serial bus (USB) flash drive and memory card), portable storage devices (e.g., external solid-state drive (SSD) and hard disk drive (HDD)), network-attached storage solid-state drive (SSD), pen drive, or other memory storage means.

In an exemplary implementation, the ticket data may be fetched using secure data communication protocols to ensure the integrity and confidentiality of the ticket data. Once the at least one processor 104 successfully fetches the ticket data, the at least one processor 104 integrates the ticket data with the onboarding details to generate a more optimized and accurate automated resolution for the plurality of tickets coming in queues provided by the at least one queue owner. It will be appreciated by the person skilled in the art that the aim here is to create a centralized platform for queue owners that provides automated resolutions for a large number of incoming tickets by using input data provided by the queue owners.

At step S406, the method 400 includes loading, by the at least one processor 104, the ticket data into a data repository to train a model for the automated ticket resolution.

In an exemplary implementation, the model (herein also referred to as a ticket resolution module (TRM)) may be trained using the ticket data provided by the at least one queue owner. The model may be a machine learning (ML) model. Using the model, the present invention overcomes the need to separately use artificial intelligence (AI) or ML models in order to provide resolutions for the plurality of tickets belonging to various categories (For example, tickets belonging to departments such as human resource (HR) need specific AI model). In an exemplary implementation, the data repository may act as a shared folder and allows the model to monitor the ticket data within the data repository for tracking a solution for the plurality of tickets.

At step S408, the method 400 includes receiving, by the at least one processor 104, at least one ticket via a ticket management platform.

In an exemplary implementation, the ticket management platform (e.g., ServiceNow API) may be connected with an automated ticket resolution system (ATRS). The ticket management platform organizes and monitors tickets received in queues (examples of queues such as information technology (IT), human resources (HR), etc.) from users. For example, a user, who wants a resolution of a ticket, may raise an IT-related ticket using the ticket management platform for getting a resolution of the ticket.

At step S410, the method 400 includes identifying, by the at least one processor 104, a resolution for the at least one ticket using the model trained from the ticket data. In an exemplary implementation, the model may monitor the ticket data within the data repository, identify a solution for the at least one ticket, and send the identified resolution for further processing.

The method 400 also includes updating, by the at least one processor 104, a ticket status of the at least one ticket as an unresolved ticket upon failure of the identification of resolution for the at least one ticket. In an exemplary implementation, if the model fails to identify the resolution of a ticket from the data repository, then the at least one processor 104 may mark the ticket as an unresolved ticket and the unresolved ticket remains in the data repository. The at least one processor 104 may further transmit a notification to the user via the at least one ticket management platform upon failure of resolution of the at least one ticket. Further, the method 400 includes transmitting, by the at least one processor 104, the at least one unresolved ticket to the ticket resolution team for a manual resolution of the at least one unresolved ticket (for example, support staff or technicians to manually solve the at least one unresolved ticket). After receiving the resolution of the at least one unresolved ticket, the method 400 includes loading, by the at least one processor 104, resolution of the at least one unresolved ticket into the data repository for self-training of the model for the automated ticket resolution. This way the present disclosure improves the solution detection rate in the long term as the ticket data accumulates within the data repository and thus the present disclosure provides an accurate solution for the plurality of tickets coming from the queue(s) provided by the users.

At step S412, the method 400 includes executing, by the at least one processor 104, the identified resolution to resolve the at least one ticket.

Upon resolving the at least one ticket, the method 400 may include transmitting, by the at least one processor 104, a notification to the user via the ticket management platform upon a successful resolution of the at least one ticket to notify the user.

In an exemplary implementation, the notification may be customized to be delivered via various channels, such as email, SMS, or even as a push notification from an application, depending on the system's capabilities and the user's preferences.

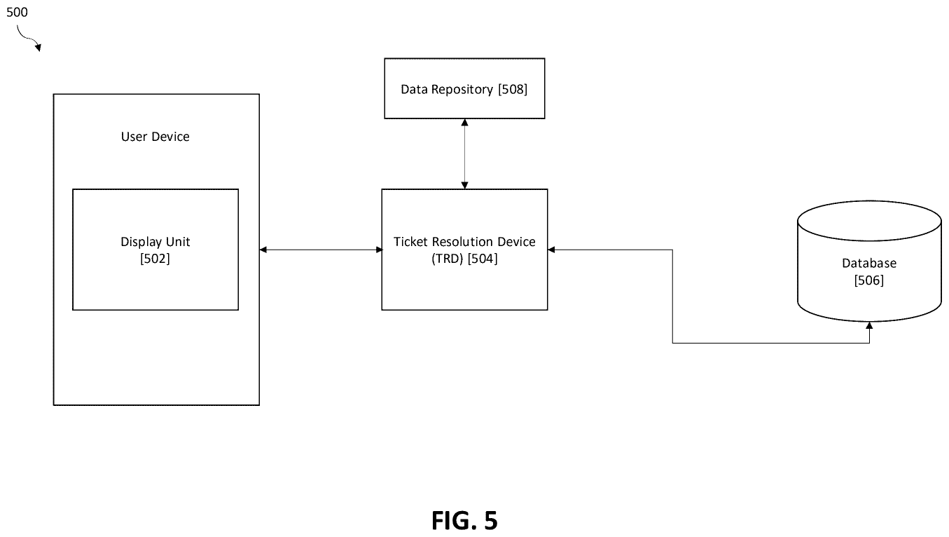

FIG. 5 illustrates a process flow diagram usable for implementing a method for providing an automated ticket resolution, in accordance with an exemplary embodiment. As illustrated in FIG. 5, the process flow 500 begins with receiving, by a ticket resolution device (TRD) 504, onboarding details from at least one queue owner. In an exemplary implementation, the TRD 504 receives a ticket data from the at least one queue owner via a user device associated with the at least one queue owner. In an exemplary implementation, a user interface (UI) may be used by the at least one queue owner to provide the onboarding details and the ticket data. The UI may be a graphical user interface (GUI). For example, the UI may be rendered on a display unit 502 of the user's device. In an exemplary implementation, the UI may be referred to as admin UI.

In an exemplary implementation, the user device may include a tablet, a smartphone, a laptop, a desktop computer, a mainframe computer, a phablet, a smart watch, a personal digital assistant (PDA), and the like.

In an exemplary implementation, the TRD 504 uploads the ticket data into a data repository 508 to train a model (also referred to as a ticket resolution module) for the automated ticket resolution. The data repository 508 may act as a shared folder and allows the model to monitor the ticket data within the data repository 508 for tracking solutions for a plurality of tickets raised by a user via the ticket management platform.

In an exemplary implementation, the TRD 504 may fetch the ticket data from external sources, including, for example, database(s) 506, solid-state drives (SSDs), or a server. The goal is to provide automated ticket resolution for the plurality of tickets. The TRD 504 may be configured to execute the method steps mentioned as follows: receive at least one ticket via the ticket management platform, identify a resolution for the at least one ticket using the model trained from the ticket data, and finally execute the identified resolution to resolve the at least one ticket. This way the TRD 504 automates ticket resolution for the plurality of tickets. Further, the TRD 504 transmits a notification to the user via the ticket management platform upon a successful resolution of the at least one ticket.

It will be appreciated by the person skilled in the art that the TRD 504 offers a full-circle, adaptable, and intelligent solution for automating the highly complex task of ticket resolution.

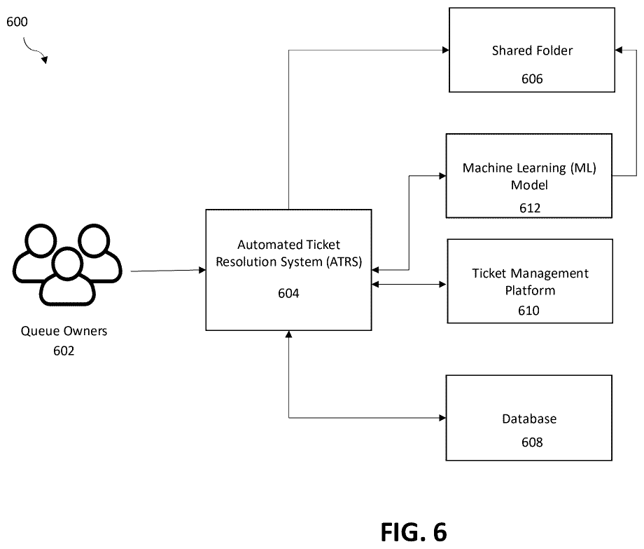

FIG. 6 illustrates a block diagram usable for implementing a method for providing an automated ticket resolution, in accordance with an exemplary embodiment of the present disclosure. As illustrated in FIG. 6, the process flow 600 begins with receiving, by an automated ticket resolution system (ATRS) (also referred to as “ticket resolution device”) 604, onboarding details from queue owner(s) 602 along with a ticket data. The ATRS completes the onboarding of the queue owner(s) 602 and registers the corresponding queue owner(s) 602 in the ATRS 604.

Further, the ticket data may be stored in a local database or a database 608 and the ticket data is also loaded into a shared folder 606 by the ATRS 604. The shared folder 606 acts as a data repository to train a machine learning (ML) model 612 (also referred to as model).

In an exemplary implementation, a ticket management platform 610 (e.g., service now API) may be connected with the ATRS 604. The ticket management platform 610 organizes tickets in queues (examples of queues such as information technology (IT), human resources (HR), etc.). Once the onboarding is completed, any ticket created in the queue(s) will be picked by the ATRS 604. Once the ML model 612 is trained on the ticket data, a given queue gets ready for processing the tickets by ATRS 604. The ML model 612 may identify a resolution for the ticket and execute the identified resolution to resolve the corresponding ticket. If the ticket is successfully resolved, then a ticket status is marked as completed. If the ML model 612 fails to resolve the ticket then the ticket is transferred to a ticket resolution team for a manual resolution of the particular ticket. Further, the resolution of the unresolved ticket is further loaded into the shared folder 606 for self-training of the ML model 612 for the automated ticket resolution. Self-training is a technique where the ML model 612 trains itself on labeled data received from the shared folder 606 and then uses its own predictions on unlabeled data to continue the learning process for ticket resolution proposes disclosed herein.

In an exemplary implementation, if a server becomes unreachable, a ‘Host Down’ ticket gets automatically created by the ticket management platform 610, indicating a potential issue with server availability. This is part of infrastructure management. This ticket acts as a notification to the technical team that there is a disruption in server operations, which could impact business processes relying on that server. This could be due to various reasons such as network failures, hardware malfunctions, or software issues. The ticket captures essential details about the server, including its identification, location, and associated teams responsible for its maintenance. To resolve the issue, the ATRS initiates a systematic approach. Once the ticket is received in the queue, ATRS automatically begins a series of ping operations to the affected server. These pings are sent every 5 minutes, up to a total of 6 attempts, to determine if the server has come back online. Each ping attempt is logged, and the ticket is updated with comments reflecting the server's status. This automated process continues until the server is confirmed to be operational or further manual intervention is deemed necessary and close the ticket accordingly.

The present invention provides several advantages as given below. The present invention allows organizations to manage the resolution of a large number of tickets on a daily basis and significantly reduces the cost of solution per ticket. The present invention helps organizations automate ticket resolution procedures with minimal intervention of support technician teams. The present invention allows queue owners belonging to different categories to upload their tickets and provides automated resolution for tickets belonging to different categories. The present invention does not require the use of customized and specific machine learning models for different types of tickets, hence reducing complexity and providing automated resolution for tickets.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions for providing an automated ticket resolution is disclosed. The instructions include executable code which, when executed by a processor 104, may cause the processor 104 to register, via a communication interface, at least one queue owner upon successful completion of an onboarding of the at least one queue owner register; receive a ticket data from the at least one queue owner, the ticket data includes data associated with a plurality of tickets and corresponding resolution of the plurality of tickets; load the ticket data into a data repository to train a model for the automated ticket resolution; receive at least one ticket via a ticket management platform; identify a resolution for the at least one ticket using the model trained from the ticket data; and execute the identified resolution to resolve the at least one ticket.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

What is claimed is:

1. A method for providing an automated ticket resolution, the method being implemented by at least one processor, the method comprising:
registering, by the at least one processor, at least one queue owner upon successful completion of an onboarding of the at least one queue owner;
receiving, by the at least one processor, a ticket data from the at least one queue owner, wherein the ticket data comprises data associated with a plurality of tickets and corresponding resolution of the plurality of tickets;
loading, by the least one processor, the ticket data into a data repository to train a model for the automated ticket resolution;
receiving, by the at least one processor, at least one ticket via a ticket management platform;
identifying, by the at least one processor, a resolution for the at least one ticket using the model trained from the ticket data; and
executing, by the at least one processor, the identified resolution to resolve the at least one ticket.

2. The method as claimed in claim 1, wherein for the onboarding of the at least one queue owner, the method further comprises:
receiving, by the at least one processor, onboarding details from the at least one queue owner;
authenticating, by the at least one processor, the at least one queue owner; and
authorizing, by the at least one processor, the at least one queue owner based on the onboarding details.

3. The method as claimed in claim 2, wherein the onboarding details comprise a name, a location, a role, and a department of the at least one queue owner.

4. The method as claimed in claim 1, wherein the method further comprises:
updating, by the at least one processor, a ticket status of the at least one ticket as an unresolved ticket upon failure of the identification of the resolution for the at least one ticket; and
transmitting, by the at least one processor, the at least one unresolved ticket to a ticket resolution team for a manual resolution of the at least one unresolved ticket.

5. The method as claimed in claim 4, wherein the resolution of the at least one unresolved ticket is further loaded into the data repository for self-training of the model for the automated ticket resolution.

6. The method as claimed in claim 1, wherein the ticket data is further uploaded in at least one format from among: a javascript object notation (JSON) format, an extensible markup language (XML) format, and a comma separated values (CSV) format.

7. The method as claimed in claim 1, wherein the method further comprises:
transmitting, by the at least one processor, a notification to the user via the ticket management platform upon successful resolution of the at least one ticket.

8. A computing device configured to implement an execution of a method for providing an automated ticket resolution, the computing device comprising:
a processor;
a memory storing instructions; and
a communication interface coupled to each of the processor and the memory,
wherein the processor is programmed to cooperate with the instructions to perform operations comprising:
registering at least one queue owner upon successful completion of an onboarding of the at least one queue owner;
receiving a ticket data from the at least one queue owner, wherein the ticket data comprises data associated with a plurality of tickets and corresponding resolution of the plurality of tickets;
loading the ticket data into a data repository to train a model for the automated ticket resolution;
receiving at least one ticket via a ticket management platform;
identifying a resolution for the at least one ticket using the model trained from the ticket data; and
executing the identified resolution to resolve the at least one ticket.

9. The computing device as claimed in claim 8, wherein to onboard the at least one queue owner, the operations further comprise:
receiving onboarding details from the at least one queue owner;
authenticating the at least one queue owner; and
authorizing the at least one queue owner based on the onboarding details.

10. The computing device as claimed in claim 9, wherein the onboarding details comprise a name, a location, a role, and a department of the at least one queue owner.

11. The computing device as claimed in claim 8, wherein the operations further comprise:
updating a ticket status of the at least one ticket as an unresolved ticket upon failure of the identification of resolution for the at least one ticket; and
transmitting the at least one unresolved ticket to a ticket resolution team for a manual resolution of the at least one unresolved ticket.

12. The computing device as claimed in claim 11, wherein the resolution of the at least one unresolved ticket is further loaded into the data repository for self-training of the model for the automated ticket resolution.

13. The computing device as claimed in claim 8, wherein the ticket data is further uploaded in at least one format from among: a javascript object notation (JSON) format, an extensible markup language (XML) format, and a comma separated values (CSV) format.

14. The computing device as claimed in claim 8, wherein the operations further comprise transmitting a notification to the user via the ticket management platform upon successful resolution of the at least one ticket.

15. A non-transitory computer readable storage medium storing instruction for providing an automated ticket resolution, the instructions comprising executable code which when executed by a processor, causes the processor to perform operations comprising:
registering at least one queue owner upon successful completion of an onboarding of the at least one queue owner;
receiving a ticket data from the at least one queue owner, wherein the ticket data comprises data associated with a plurality of tickets and corresponding resolution of the plurality of tickets;
loading the ticket data into a data repository to train a model for the automated ticket resolution;
receiving at least one ticket via a ticket management platform;
identifying a resolution for the at least one ticket using the model trained from the ticket data; and
executing the identified resolution to resolve the at least one ticket.

16. The non-transitory computer readable storage medium as claimed in claim 15, wherein for the onboarding of the at least one queue owner, the operations further comprise:
receiving onboarding details from the at least one queue owner;
authenticating the at least one queue owner; and
authorizing the at least one queue owner based on the onboarding details.

17. The non-transitory computer readable storage medium as claimed in claim 16, wherein the onboarding details comprise a name, a location, a role, and a department of the at least one queue owner.

18. The non-transitory computer readable storage medium as claimed in claim 15, wherein the operations further comprise:
updating a ticket status of the at least one ticket as an unresolved ticket upon failure of the identification of resolution for the at least one ticket; and
transmitting the at least one unresolved ticket to a ticket resolution team for a manual resolution of the at least one unresolved ticket.

19. The non-transitory computer readable storage medium as claimed in claim 15, wherein the resolution of the at least one unresolved ticket is further loaded into the data repository for self-training of the model for the automated ticket resolution.

20. The non-transitory computer readable storage medium as claimed in claim 15, wherein the operations further comprise transmitting a notification to the user via the ticket management platform upon successful resolution of the at least one ticket.
